(19) United States
(12) Patent Application Publication
(10) Pub. No.: US 2002/0018424 A1
(43) Pub. Date: Feb. 14, 2002

(54) Computer case

(76) Inventor: Daniel Yeh, Taipei (TW)

Correspondence Address: GOTTLIEB RACKMAN & REISMAN PC, 270 MADISON AVENUE, 8TH FLOOR, NEW YORK, NY, 100160601

(21) Appl. No.: 09/855,419

(22) Filed: May 15, 2001

(30) Foreign Application Priority Data
Aug. 11, 2000 (TW) 89213999

(51) Int. Cl. G11B 33/02

(52) U.S. Cl. 369/75.1

(57) ABSTRACT

There is provided a computer case furnished with a multimedia playing device and integrally formed with the multimedia playing device on the top surface of the computer case, for accessing a multimedia medium in a safe way.

### FIELD OF THE INVENTION

The present invention is generally related to a computer case. In particular, the present invention is related to a computer case furnished with a multimedia playing device, in which the multimedia playing device is integrally formed with the computer case on the top surface of the computer case.

### BACKGROUND OF THE INVENTION

As far as the contemporary computer case is concerned, the compact disc (CD) playing device is arranged to fix to the side slot of the computer case. When a computer user intends to utilize the CD playing device mounted on a computer to access the data contained on a compact disc, he has to touch the eject key on the control panel of the CD playing device to horizontally draw the tray of the CD playing device out of the CD playing device, load the compact disc into the appropriate position of the tray, and then horizontally return the tray back into the CD playing device. In this way, the computer user can access the data contained in the compact disc softly.

Nevertheless, a few shortcomings are still subsistent in the CD playing device mounted on a computer. Because the computer user has to load the compact disc into the appropriate position of the tray and then horizontally return the tray back inside the CD playing device, assuming that the computer user does not accurately place the compact disc at the appropriate position on the tray, the compact disc is easily to get impaired as the tray which is loaded with a compact disc is horizontally returning back into the CD playing device.

Taking a CD stereo as an example, generally the CD playing device is installed on the top surface of a CD stereo. While a philharmonic person desires to utilize the CD stereo to play the audio tracks contained on a compact disc, he has to touch the eject key on the control panel of the CD stereo to eject the tray cover of the CD playing device upwardly, load the compact disc on the tray of the CD playing device, then force the tray cover down to enclose the tray of the CD stereo. Subsequently, the philharmonic person can start to play the audio tracks stored on the compact disc.

Based on the idea of the arrangement of the CD playing device on a CD stereo, if the CD playing device can be incorporated into a computer case and integrally formed with the computer case on the top surface of the computer case, such a novel mechanism can suppress the aforesaid shortcomings encountered by the prior art and provide a convenient and friendly user interface.

It is tried by the applicant to develop a computer case furnished with a multimedia playing device.

### SUMMARY OF THE INVENTION

Therefore, an object of the invention is to provide a computer case furnished with a multimedia playing device.

Another object of the invention is to provide a computer case with a multimedia playing device being integrally formed with the computer case on the top surface of the computer case.

In a broad interpretation of the preferred embodiment of the invented computer case, the computer case comprises a computer case body, and a multimedia playing device, for example, a compact disc (CD) playing device, being incorporated into the computer case body for accessing a multimedia medium such as a compact disc (CD). Generally speaking, the multimedia playing device includes a tray for loading the multimedia medium and a tray cover which is allowable to be ejected upwardly and forced downwardly to enable the multimedia medium to be loaded into the tray and unloaded from the tray.

In accordance with a second aspect of the preferred embodiment of the invented computer case, the computer case comprises a computer case body, and a multimedia playing device, for example, a compact disc (CD) playing device, being integrally formed with the computer case body on the top surface of the computer case body for accessing a multimedia medium such as a compact disc (CD). Generally speaking, the multimedia playing device includes a tray for loading the multimedia medium and a tray cover which is allowable to be ejected upwardly and forced downwardly to enable the multimedia medium to be loaded into the tray and unloaded from the tray.

Now the foregoing and other features of the invention may best be understood through the following descriptions with reference to the drawing, in which:

### BRIEF DESCRIPTION OF THE DRAWINGS

FIG. 1 is the perspective view of the invented computer case furnished with a multimedia playing, with the multimedia playing device is integrally formed with the computer case on the top surface of the invented computer case.

### DETAILED DESCRIPTION OF THE PREFERRED EMBODIMENT

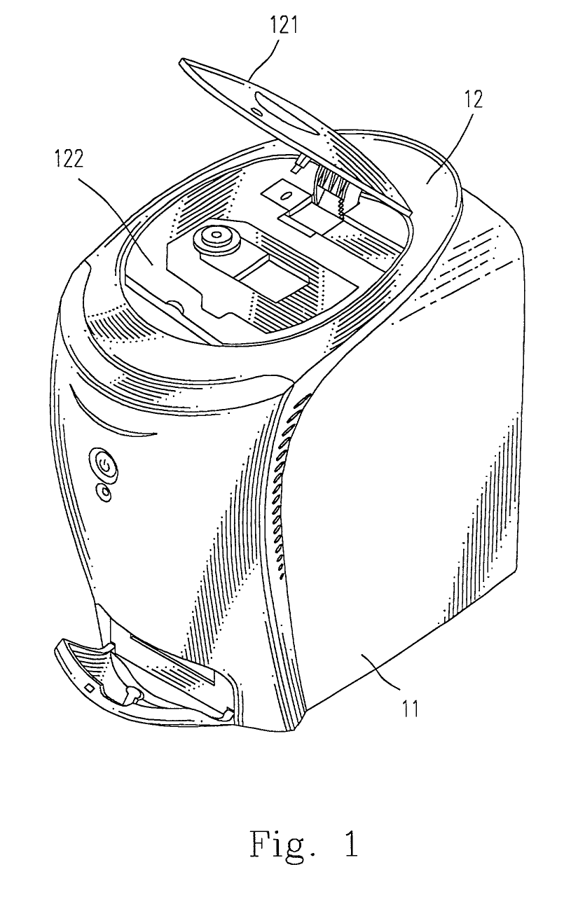

The computer case embodying the present invention will be illustrated to the best advantage by the following embodiment and the accompanying drawing. As can be seen from FIG. 1, the computer case of the present invention comprises a computer case body 11 and a multimedia playing device 12 incorporated therein. The multimedia playing device 12 in this preferred embodiment is directed a CD (compact disc) playing device. The CD playing device 12 is incorporated into the computer case body 11 and integrally formed with the computer case body 11 on the top surface of the computer case body 11. The CD playing device 12 includes a tray 122 for loading a compact disc and a tray cover 121 which is allowable to be ejected upwardly and forced downwardly to enable a multimedia medium, for example, a compact disc, to be loaded into the tray 122 and unloaded from the tray 122. In this manner, as long as the compact disc is loaded into the tray 122 and seal the tray 122 with the tray cover 121, the computer user can access the data contained in the compact disc with ease, without concerning whether the compact disc is impaired caused by the compact disc being loaded into the inappropriate position of the tray.

To the brief, the computer case of the present invention facilitates the access of the multimedia medium in the respect of incorporating a multimedia playing device and integrally forming with the multimedia playing device on the top surface of the computer case. The computer case formed thereby can provide a flexible and secure multimedia access channel for the computer users.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the invention which is defined by the appended claims.

I claim:

1. A computer case comprising:
a computer case body; and
a multimedia playing device being incorporated into said computer case body for accessing a multimedia medium.

2. The computer case as set forth in claim 1, wherein said multimedia playing device comprises:
a tray for loading said multimedia medium; and
a tray cover which is allowable to be ejected upwardly and forced downwardly to enable said multimedia medium to be loaded into said tray and unloaded from said tray.

3. The computer case as set forth in claim 1, wherein said multimedia playing device is a compact disc (CD) playing device.

4. The computer case as set forth in claim 1, wherein said multimedia medium is a compact disc (CD).

5. A computer case comprising:
a computer case body; and
a multimedia playing device being integrally formed with said computer case body on the top surface of said computer case body for accessing a multimedia medium.

6. The computer case as set forth in claim 5, wherein said multimedia playing device comprises:
a tray for loading said multimedia medium; and
a tray cover which is allowable to be ejected upwardly and forced downwardly to enable said multimedia medium to be loaded into said tray and unloaded from said tray.

7. The computer case as set forth in claim 5, wherein said multimedia playing device is a compact disc (CD) playing device.

8. The computer case as set forth in claim 5, wherein said multimedia medium is a compact disc (CD).

9. A computer case, characterized by said computer case is furnished with a multimedia playing deice and integrally formed with said multimedia playing deice on the top surface of said computer case.

10. The computer case as set forth in claim 9, wherein said multimedia playing device comprises:
a tray for loading a multimedia medium; and
a tray cover which is allowable to be ejected upwardly and forced downwardly to enable said multimedia medium to be loaded into said tray and unloaded from said tray.

11. The computer case as set forth in claim 9, wherein said multimedia playing device is a compact disc (CD) playing device.

12. The computer case as set forth in claim 10, wherein said multimedia medium is a compact disc (CD).
